(19) United States
(12) Patent Application Publication
(10) Pub. No.: US 2009/0132253 A1
(43) Pub. Date: May 21, 2009

(54) Context-aware unit selection

(76) Inventor: Jerome Bellegarda, Los Gatos, CA (US)

Correspondence Address: James C. Scheller, Jr.;BLAKELY, SOKOLOFF, TAYLOR & ZAFMAN LLP, 1279 Oakmead Parkway, Sunnyvale, CA, 94085-4040, US

(21) Appl. No.: 11/986,515

(22) Filed: Nov. 20, 2007

(51) Int. Cl. G10L 13/00

(52) U.S. Cl. 704/258; 704/E13.005

(57) ABSTRACT

Methods and apparatuses to perform context-aware unit selection for natural language processing are described. Streams of information associated with input units are received. The streams of information are analyzed in a context associated with first candidate units to determine a first set of weights of the streams of information. A first candidate unit is selected from the first candidate units based on the first set of weights of the streams of information. The streams of information are analyzed in the context associated with second candidate units to determine a second set of weights of the streams of information. A second candidate unit is selected from second candidate units to concatenate with the first candidate unit based on the second set of weights of the streams of information.

### FIELD OF THE INVENTION

The present invention relates generally to language processing. More particularly, this invention relates to weighting of unit characteristics in language processing.

### BACKGROUND

Concatenative text-to-speech (“TTS”) synthesis generates the speech waveform corresponding to a given sequence of phonemes through the sequential assembly of pre-recorded segments of speech. These segments may be extracted from sentences uttered by a professional speaker, and stored in a database. Each such segment is usually referred to as a unit. During synthesis, the database may be searched for the most appropriate unit to be spoken at any given time, a process known as unit selection. This selection typically relies on a plurality of characteristics reflecting, for example, the degree of discontinuity from the previous unit, the departure from ideal values for pitch and duration, the spectral quality relative to the average matching unit present in the database, the location of the candidate unit in the recorded utterance, etc.

To select the unit, two requirements need to be fulfilled: (i) each individual characteristic needs to meaningfully score each potential candidate relative to all other available candidates, and (ii) these individual scores needs to be appropriately combined into a final score, which then may serve as the basis for unit selection.

The typical approaches to achieve requirement (ii) have been to consider a linear combination of the various scores, where the weights are empirically determined via careful human listening. In that case the synthesized material is inherently limited to a tractably small number of sentences, sometimes not even particularly representative of the eventual (unknown) domain of use. That is, in the existing techniques, the weights are manually tuned in a global fashion by listening to a necessarily small amount of synthesized material. Additionally, the existing techniques define weightings for the entire corpus of samples and apply those defined weightings across all samples.

These strategies have obvious drawbacks, including a lack of scalability and the need for human supervision. Most importantly, they often lead to a set of weights which fails to generalize beyond the initial set of sentences considered. In other words, in the existing techniques there is no guarantee that the weights obtained by “trial and error” approach will generalize to new material. In fact, because no single combination of scores can possibly be optimal for all concatenations, these techniques are essentially counter-productive.

Alternatively, it is also possible to view each scoring source as generating a separate stream of information, and apply standard voting methods and other known learning/classification techniques to try to combine the ensuing outcomes. Unfortunately, the various streams tend to (i) be correlated with each other in complex, time-varying ways, and (ii) differ unpredictably in their discriminative value depending on context, thereby violating many of the assumptions implicitly underlying such techniques.

### SUMMARY OF THE DESCRIPTION

Methods and apparatuses to perform context-aware unit selection for natural language processing are described. Dynamic characteristics (“streams of information”) associated with input units may be received. An input unit of the sequence of input units may be a phoneme, a diphone, a syllable, a half phone, a word, or a sequence thereof. A stream of information of the streams of information associated with the input units may represent, for example, a pitch, duration, position, accent, spectral quality, a part-of-speech, any other relevant characteristic that can be associated with the input unit, or any combination thereof. In one embodiment, the stream of information includes a cost function. The streams of information may be analyzed in a context associated with a pool of candidate units to determine a distribution of the streams of information over the candidate units. For example, a stream of information that varies the most within the pool of the candidate units may be determined. A first set of weights of the streams of information may be automatically determined according to the distribution of the streams of information within the pool of candidate units. A first candidate unit is selected from the pool based on the automatically determined set of weights of the streams of information. Further, the streams of information are analyzed in the context associated with a pool of second candidate units to automatically determine a second set of weights of the streams of information associated with the second candidate units. A second candidate unit is selected from the pool of second candidate units to concatenate with the first candidate unit based on the second set of weights of the streams of information. In one embodiment, the sets of streams of information are automatically dynamically computed at each concatenation.

In one embodiment, the analyzing of the streams of information includes weighting a stream of information higher if the stream of information provides a high discrimination between the candidate units. In one embodiment, the analyzing of the streams of information includes weighting a stream of information lower if the stream of information provides a low discrimination between the candidate units.

In one embodiment, scores associated with streams of information for candidate units associated with an input unit are determined. A matrix of the scores for the candidate units may be generated. A set of weights may be determined using the matrix. First final costs for the candidate units using the set of weights may be determined. A candidate unit may be selected from the candidate units based on the final costs.

Other features will be apparent from the accompanying drawings and from the detailed description which follows.

### BRIEF DESCRIPTION OF THE DRAWINGS

The present invention is illustrated by way of example and not limitation in the figures of the accompanying drawings in which like references indicate similar elements.

FIG. 1 shows a block diagram of a data processing system to perform context-aware unit selection for natural language processing according to one embodiment of invention.

FIG. 2 shows a block diagram illustrating a data processing system to perform context-aware unit selection for natural language processing according to one embodiment of the invention.

FIG. 3 shows a flowchart of one embodiment of a method to perform a content-aware unit selection for natural language processing.

FIG. 4 shows a flowchart of another embodiment of a method to perform a content-aware unit selection for natural language processing.

FIG. 5A illustrates one embodiment of forming a matrix of scores for candidate units.

FIG. 5B illustrates one embodiment of matrix multiplication with an unknown weight vector that yields final costs.

FIG. 6 illustrates the sorted final costs for word “are”, for both context-aware optimal cost weighting and standard (default) weighting.

FIG. 7 illustrates the sorted final costs for word “lines”, for both context-aware optimal cost weighting and standard (default) weighting.

FIG. 8 illustrates the sorted final costs for word “longer”, for both context-aware optimal cost weighting and standard (default) weighting.

### DETAILED DESCRIPTION

The subject invention will be described with references to numerous details set forth below, and the accompanying drawings will illustrate the invention. The following description and drawings are illustrative of the invention and are not to be construed as limiting the invention. Numerous specific details are described to provide a thorough understanding of the present invention. However, in certain instances, well known or conventional details are not described in order to not unnecessarily obscure the present invention in detail.

Reference throughout the specification to “one embodiment”, “another embodiment”, or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Methods and apparatuses to perform context-aware unit selection for natural language processing and a system having a computer readable medium containing executable program code to perform context-aware unit selection for natural language processing are described below. A machine-readable medium may include any mechanism for storing information in a form readable by a machine (e.g., a computer). For example, a machine-readable medium includes read only memory (“ROM”); random access memory (“RAM”); magnetic disk storage media; optical storage media; and flash memory devices.

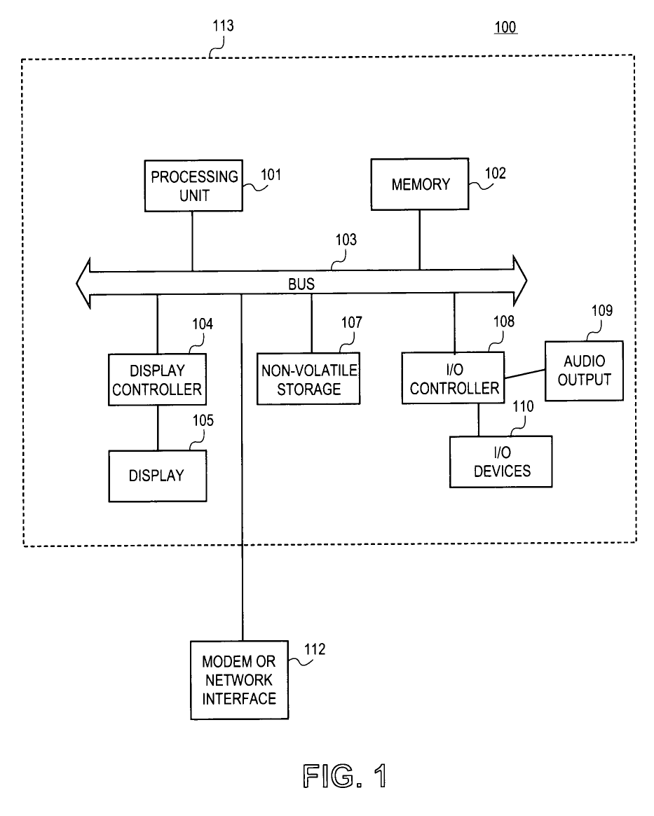

FIG. 1 shows a block diagram 100 of a data processing system to perform context-aware unit selection for natural language processing according to one embodiment of invention. Data processing system 113 includes a processing unit 101 that may include a microprocessor, such as an Intel Pentium® microprocessor, Motorola Power PC® microprocessor, Intel Core™ Duo processor, AMD Athlon™ processor, AMD Turion™ processor, AMD Sempron™ processor, and any other microprocessor. Processing unit 101 may include a personal computer (PC), such as a Macintosh® (from Apple Inc. of Cupertino, Calif.), Windows®-based PC (from Microsoft Corporation of Redmond, Wash.), or one of a wide variety of hardware platforms that run the UNIX operating system or other operating systems. For one embodiment, processing unit 101 includes a general purpose data processing system based on the PowerPC®, Intel Core™ Duo, AMD Athlon™, AMD Turion™ processor, AMD Sempron™, HP Pavilion™ PC, HP Compaq™ PC, and any other processor families. Processing unit 101 may be a conventional microprocessor such as an Intel Pentium microprocessor or Motorola Power PC microprocessor.

As shown in FIG. 1, memory 102 is coupled to the processing unit 101 by a bus 103. Memory 102 can be dynamic random access memory (DRAM) and can also include static random access memory (SRAM). A bus 103 couples processing unit 101 to the memory 102 and also to non-volatile storage 107 and to display controller 104 and to the input/output (I/O) controller 108. Display controller 104 controls in the conventional manner a display on a display device 105 which can be a cathode ray tube (CRT) or liquid crystal display (LCD). The input/output devices 110 can include a keyboard, disk drives, printers, a scanner, and other input and output devices, including a mouse or other pointing device. One or more input devices 110, such as a scanner, keyboard, mouse or other pointing device can be used to input a text for speech synthesis. The display controller 104 and the I/O controller 108 can be implemented with conventional well known technology. An audio output 109, for example, one or more speakers may be coupled to an I/O controller 108 to produce speech. The non-volatile storage 107 is often a magnetic hard disk, an optical disk, or another form of storage for large amounts of data. Some of this data is often written, by a direct memory access process, into memory 102 during execution of software in the data processing system 113. One of skill in the art will immediately recognize that the terms “computer-readable medium” and “machine-readable medium” include any type of storage device that is accessible by the processing unit 101. A data processing system 113 can interface to external systems through a modem or network interface 112. It will be appreciated that the modem or network interface 112 can be considered to be part of the data processing system 113. This interface 112 can be an analog modem, ISDN modem, cable modem, token ring interface, satellite transmission interface, or other interfaces for coupling a data processing system to other data processing systems.

It will be appreciated that data processing system 113 is one example of many possible data processing systems which have different architectures. For example, personal computers based on an Intel microprocessor often have multiple buses, one of which can be an input/output (I/O) bus for the peripherals and one that directly connects the processing unit 101 and the memory 102 (often referred to as a memory bus). The buses are connected together through bridge components that perform any necessary translation due to differing bus protocols.

Network computers are another type of data processing system that can be used with the embodiments of the present invention. Network computers do not usually include a hard disk or other mass storage, and the executable programs are loaded from a network connection into the memory 102 for execution by the processing unit 101. A Web TV system, which is known in the art, is also considered to be a data processing system according to the embodiments of the present invention, but it may lack some of the features shown in FIG. 1, such as certain input or output devices. A typical data processing system will usually include at least a processor, memory, and a bus coupling the memory to the processor.

It will also be appreciated that the data processing system 113 is controlled by operating system software which includes a file management system, such as a disk operating system, which is part of the operating system software. One example of operating system software is the family of operating systems known as Macintosh® Operating System (Mac OS®) or Mac OS X® from Apple Inc. of Cupertino, Calif. Another example of operating system software is the family of operating systems known as Windows® from Microsoft Corporation of Redmond, Wash., and their associated file management systems. The file management system is typically stored in the non-volatile storage 107 and causes the processing unit 101 to execute the various acts required by the operating system to input and output data and to store data in memory, including storing files on the non-volatile storage 107.

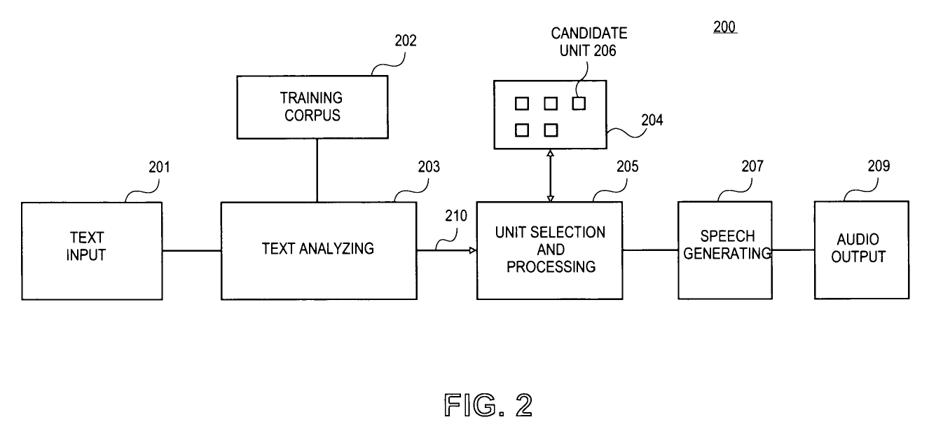

FIG. 2 shows a block diagram illustrating a data processing system to perform context-aware unit selection for natural language processing according to one embodiment of the invention. Generally, the context-aware unit selection may be performed for many natural language processing (“NLP”) applications, for example, from low-level applications, such as grammar checking and text chunking, to high-level applications, such as text-to-speech synthesis (“TTS”), speech recognition and machine translation applications. In one embodiment, data processing system 200 performs context-aware unit selection based on optimal cost weighting for text-to-speech (“TTS”) synthesis. A text analyzing module 203 may receive a text input 201, for example, one or more words, sentences, paragraphs, and the like. Text analyzing module 203 may analyze the text to extract units. The extracted units may include a phoneme, a diphone (the span between the middle of one phoneme and the middle of another phoneme), a syllable, a half phone, a word, or any combination thereof. Analyzing unit 203 may determine characteristics of a unit and assign these characteristics to the unit. The characteristics of the unit may be, for example, a pitch, duration, accent, spectral quality, position in a sequence of units, degree of discontinuity from a previous unit, a part-of-speech characteristic, any other relevant characteristic that can be extracted from a signal associated with a unit, and any combination thereof. The characteristics of the input sentence to be synthesized into speech may be determined based on models indicating how these characteristics (e.g., a pitch) should evolve for that input sentence, what the optimal duration of each word in the sentence should be, and/or where to place an accent, for example. In one embodiment, analyzing unit 203 analyzes the input text to assign the characteristics to the input units that indicate how the input sentence should be spoken.

In one embodiment, analyzing unit 203 may determine a part-of-speech characteristic to an extracted word. The part-of-speech characteristic typically defines whether a word in a sentence is, for example, a noun, verb, adjective, preposition, and/or the like. In one embodiment, analyzing unit 203 analyzes text input 201 to determine a POS characteristic of a word of input text 201 using a latent semantic analogy, as described in a co-pending patent application Ser. No. 11/906,592 entitled “PART-OF-SPEECH TAGGING using LATENT ANALOGY” filed on Oct. 2, 2007, which is incorporated herein in its entirety.

As shown in FIG. 2, system 200 includes a training corpus 202 that contains a pool of training words and training word sequences. Training corpus 202 may be stored in a memory incorporated into text analyzing module 203, and/or be stored in a separate entity coupled to text analyzing module 203. In one embodiment, text analyzing module 203 determines a POS characteristic of a word from input text 201 by selecting one or more word sequences from the training corpus 202. In one embodiment, text analyzing module 203 assigns POS tags to words of the input text.

As shown in FIG. 2, text analyzing module 203 passes one or more extracted input units and their associated characteristics (“streams of information”) to unit selection and processing module 205. As shown in FIG. 2, unit selection and processing module 205 receives streams of information associated with input units 210. Unit selection and processing module 205 may select a candidate unit from a pool 204 of candidate units, such as a candidate unit 206, based on the received input unit and the streams of information associated with the input unit.

Unit selection and processing module 205 analyzes the streams of information in a context associated with pool 204 of candidate units. For example, an input word “apple” is passed from text analyzing module 203 to module 205. Module 205 searches for a candidate word “apple” from pool 204 based on the streams of information 210 associated with input word “apple”. The pool 204 may contain, for example 1 to hundreds or more candidate words “apple”. The candidate words in the pool 204 may come from different utterances and have different characteristics attached. For example, the candidate words “apple” may have different pitch characteristics. The candidate words may have different position characteristics. For example, the words that come from the end of the sentence are typically pronounced longer than words from the other positions in the sentence. The candidate words may have different accent characteristics. Pool 204 may be stored in a memory incorporated into unit selection and processing module 205, and/or be stored in a separate entity coupled to unit selection and processing module 205.

Module 205 may compute a measure for each candidate word “apple” from the pool that indicates how the stream of information for each of candidate units deviates from the stream of information associated the input unit, or ideal unit. For example, the measure may be a cost function that is calculated for each candidate unit to indicate how the pitch, duration, or accent deviates from an ideal contour. Unit selection and processing module 205 may select a candidate unit from pool 204 that is the best for the sentence to be synthesized based on the measure.

In one embodiment, unit selection and processing module 205 analyzes streams of information 210 in the context associated with pool 204 of candidate units to determine an optimal set (combination) of the streams of information. That is, the determined combination of streams of information to properly select a candidate unit from the pool of candidate units is context aware. In one embodiment, the context of the pool 204 of candidate units is analyzed to determine which streams of information are more important and which streams of information are less important in a combination of the streams of information. In one embodiment, to determine this, the streams of information associated with candidate units are evaluated, and the stream of information that vary more across all candidate units from the pool are considered as more important, and the streams of information that vary less across all candidate units from the pool are considered less important. For example, if all candidate units have substantially the same duration, so they substantially are not discriminated between each other in duration, the duration information may be considered as less important. For example, if the candidate units vary strongly in pitch, so they are substantially discriminated between each other in pitch, the pitch information is considered more important. In one embodiment, the weight zero is assigned to the stream of information that is least important, and weight 1 may be assigned to the stream of information that is most important in the set of streams of information. That is, the available mass for the weights is distributed on one or more streams of information that are important to discriminate between the candidate units. In one embodiment, a first candidate unit is selected from the pool 206 based on the first set of the streams of information, as described in further detail below.

In one embodiment, unit selection and processing module 205 analyzes the streams of information in the context associated with a pool of second candidate units to determine a second set of weights of the streams of information. Unit selection and processing module 205 selects a second candidate unit from the pool of second candidate units based on the second set of weights of the streams of information. In one embodiment, unit selection and processing module 205 concatenates second candidate unit with the first candidate unit. That is, the optimal sets (combinations) of streams of information are computed dynamically at each concatenation of one unit with another unit. The weights of each of the streams of information in the combination are adjusted locally, at each concatenation to determine an optimal combination of streams of information (e.g., costs) for each concatenation. The weights of each of the streams of information vary dynamically from concatenation to concatenation, based on what is needed at a particular point in time, as well as what is available at this particular point in time. In one embodiment, a set of optimal weights is computed dynamically (e.g., on a per concatenation basis) so as to maximize discrimination between the candidate units, such as candidate unit 206, by the unit selection process at each concatenation, as described in further detail below.

Such dynamic, local approach, as opposed to just global adjustment, leads to the selection of better individual units, and makes the entire process more consistent across the different concatenations considered, for example, in Viterbi search. In one embodiment, unit selection and processing module 205 concatenates selected units together, smoothes the transitions between the concatenated units, and passes the concatenated units to a speech generating module 207 to enable the generation of a naturalized audio output 209, for example, an utterance, spoken paragraph, and the like.

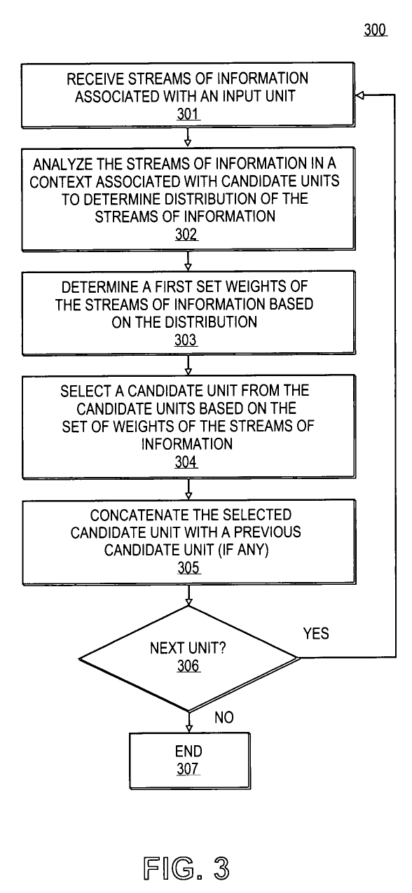

FIG. 3 shows a flowchart of one embodiment of a method to perform a content-aware unit selection for natural language processing. Method 300 begins with operation 301 that involves receiving streams of information associated with an input unit of a set of one or more input units , for example, streams of information 210, as described above with respect to FIG. 2. The streams of information (characteristics) may represent, for example, a pitch, duration, position, accent, spectral quality, a part-of-speech, any other relevant characteristic that can be extracted from a signal associated with an input unit, or any combination thereof of the input unit. In one embodiment, a stream of information associated with the input unit includes a cost function (“cost”). The cost of the stream of information may be calculated for each of the candidate units of a pool. The crux of the problem is that no single combination (set) of streams of information associated with the input units, for example cost functions (“costs”) will be optimal for all concatenations.

The concatenation may be understood as an act of drawing a candidate unit from a pool 204 of candidate units and placing the candidate unit next to a previous unit, coupling and/or linking of the candidate unit with the previous unit. If, for example, at a particular concatenation all potential candidate units have the same duration, the stream of information that represents duration may not have substantial value in the ranking and selection process. If, on the other hand, at another concatenation all potential candidate units have otherwise similar characteristics (streams of information) but differ greatly in their duration, the stream of information that represent duration may be critical to selection of the best unit at this concatenation. Thus, attempting to find optimal cost weights on a global basis, as is currently done, is essentially counter-productive (regardless of the approach considered).

Method 300 continues with operation 302 that involves analyzing the streams of information in a context associated with a pool of candidate units for the input unit, for example pool 204, to determine a distribution of the streams of information over the pool. For example, analyzing of the streams of information may include weighting a stream of information of the streams of information higher if the first stream of information provides a high discrimination between the candidate units, and weighting a stream of information of the streams of information lower if the stream of information provides a low discrimination between the candidate units.

Method continues with operation 303 that involves determine a set of weights of the streams of information based on the distribution. In one embodiment, during speech synthesis, each of the streams of information (characteristics) are dynamically weighted in real-time based on the distribution of these characteristics within a given set of input units (e.g., a sentence) being synthesized. In one embodiment, it is determined which streams of information for the candidate units in the pool vary the most, and weighting the streams of information according to how much variation there is for that stream of information in the pool of candidate units. For example, if the units in a pool have the same pitch, but vary in another characteristic, for example, in duration, then that other characteristic will be given more weight in choosing the right unit from the pool of candidate units to use for the speech synthesis. That is, the weightings of the streams of information for pools of candidate units can be varied and tailored to a particular stream of information for the candidate units in the pool, as described in further detail below.

Method continues with operation 304 that involves selecting a candidate unit from the candidate units based on the set of weights of the streams of information, as described in further details below. At operation 305 the selected candidate unit can be concatenated with a previously selected candidate unit (if any). At operation 306 a determination is made whether a next candidate unit needs to be concatenated with a previous unit, such as the unit selected at operation 304. If there is a next unit to be concatenated with the previously selected candidate unit, method 300 returns to operation 301 to receive streams of information associated with the next input unit. Further, the streams of information are analyzed in the context associated with a pool of candidate units for the next input unit at operation 302. In one embodiment, the distribution of the streams of information over the candidate units associated with the next input unit is determined. A set of weights of the streams of information associated with the candidate units for the next input unit is determined according to the distribution at operation 303. A next candidate unit for the next input unit is selected from the pool of the candidate units to concatenate with the previously selected candidate unit based on the set of weights of the streams of information associated with the candidate units for the next input unit at operation 304, as described in further detail below. At operation 305 the next selected candidate unit is concatenated with the previously selected candidate unit. If there is no next unit to be selected, method 300 ends at block 307.

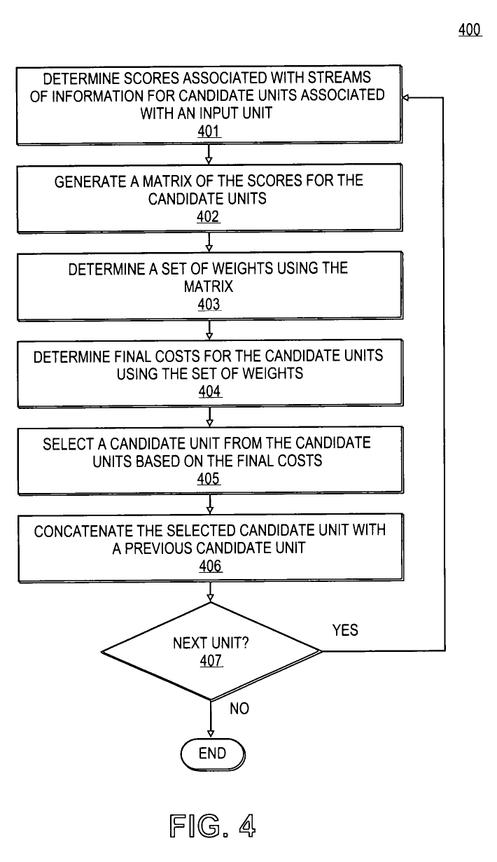

FIG. 4 shows a flowchart of another embodiment of a method to perform a content-aware unit selection for natural language processing. Method begins with operation 401 that involves determining scores associated with streams of information for first candidate units. The first candidate units may be associated with a first input unit of a sequence of input units. In one embodiment, determining the scores associated with the streams of information for first candidate units includes determining the cost functions (costs) of the streams of information for each candidate unit. The final cost of the set of streams of information for a candidate unit may be determined based on the individual costs of each of the streams of information for the candidate unit. For example, there may be a cost for smoothness (concatenation cost) that typically indicates how well the candidate unit attaches to a previous candidate unit, is there going to be a discontinuity, and if so, how salient is it. There may be a cost for pitch, for example, that indicates how well the pitch in the candidate unit matches the pitch that is required in the new input sequence of units (e.g., sentence).

For example, for a given concatenation, all potential candidate units may be collected from a pool stored, for example, in a voice table. Then, for each such candidate unit, all scores associated with various streams of information may be computed. For example, a concatenation score may be computed that measures how the candidate unit fits with the previous unit, a pitch score may be computed that reflects how close the candidate unit is to the desired pitch contour, a duration score may be computed that measures how close the duration is to the desired duration, etc. That is, the scores associated with the streams of information are determined across all candidate units of the pool on a per concatenation basis. In one embodiment, the scores are individually normalized across all potential candidate units from the pool. In one embodiment, the scores are arranged into an input matrix. Method continues with operation 402 that involves generating a matrix of the scores for the candidate units.

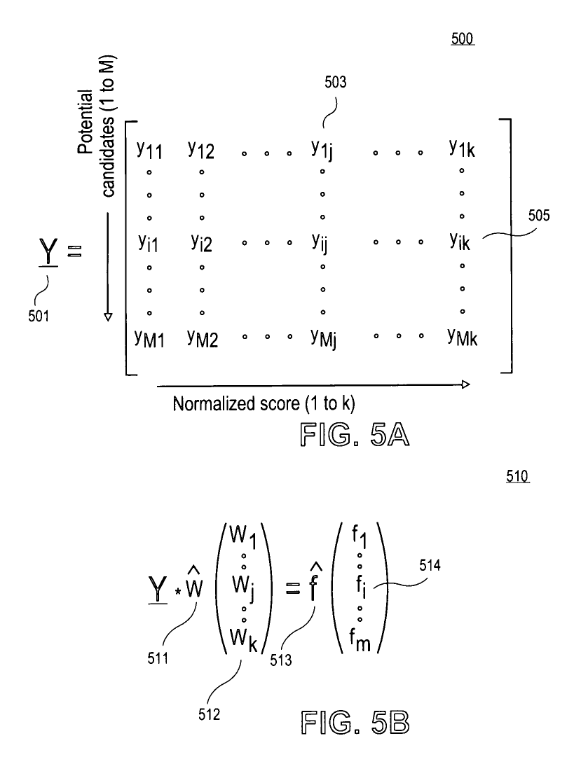

FIG. 5A illustrates one embodiment of forming a matrix Y of the scores for the candidate units. For example, a pool stored, for example, in a voice table, contains N possible candidate units, for example, candidate words “apple” at a particular point in the synthesis process, for example, at each concatenation. Each of M candidate units has associated streams of information that represent, for example, pitch, duration, accent, and the like.

For each candidate unit K different scores may be computed that are associated with each of the streams of information that may represent a different aspect of perceptual quality (pitch, duration, etc.). Each of these scores typically corresponds to a non-negative cost penalty. Each of the individual scores may be normalized across all N candidate units to the range [0, 1], through subtraction of the minimum value and division by the maximum value. As shown in FIG. 5, a (M×K) matrix Y (501) of scores yij is constructed, where rows 1 to M, such as a row 505, correspond to candidate units, and columns 1 to K, such as a column 503 corresponds to a normalized score. M may be as high as a few tens of thousands, while K is typically less than 20.

The normalized score distributions obtained across all potential candidates for each stream of information may be dynamically leveraged. In one embodiment, the streams of information that have greater variation of the scores resulting in a high discrimination between potential candidate units of the pool are locally rewarded by assigning a greater weight, and the streams of information that have less variation of the scores and therefore are less discriminative are penalized, for example, by assigning a lesser weight. In one embodiment, a constrained quadratic optimization is performed to find the optimal set of weights in the linear combination of all the scores available, as described in further detail below. A final cost so obtained is then used in the ranking and selection procedure carried out in unit selection text-to-speech (TTS) synthesis, as described in further detail below.

Referring back to FIG. 4, method 400 continues with operation 403 that involves determining a set of weights using the matrix, such as matrix Y (501). In one embodiment, determining the set of weights includes maximizing the final costs for the first candidate units, as described in further detail below. The final costs can be obtained via linear combination of the scores yij in Y (501), where the weights are unknown. For example, matrix multiplication with an unknown weight vector can be performed that yields the final costs for all candidate units.

In matrix form:

Y w=f (1)

where f (513) is a vector of final costs fᵢ (514) for all candidate units (1≦i≦M), and w (511) is a vector of desired weights wⱼ(512) (1≦j≦K) for the streams of information, as shown in FIG. 5B. Element 514 of vector 513 is a final cost for i^{th} candidate unit, as shown in FIG. 5B. In one embodiment, solving the quadratic problem associated with (1) results in the optimal weight vector at this concatenation.

In one embodiment, a candidate unit may be selected at any given point (e.g., at any concatenation) from a set of candidate units which are as distinct from one another as they possibly can, to achieve the greatest degree of discrimination between them. In other words, we would like to find the smallest final cost among that set of final costs fi where individual fi's are as uniformly large as possible. This is a classic minimax problem that involves finding a minimum amongst a set that has been maximized. For example, the minimum final cost fi is found in the final cost vector f which has maximum norm. That is, a minimum needs to be found amongst a set of final costs that has been maximized.

As such, the norm of final cost vector f is maximized. The weights of the streams of information may be chosen to maximize the norm of the final cost vector. By maximizing the norm of the final cost vector, the weights may be made as big as possible. By making the weights as big as possible the importance of each of the streams is maximized as much as possible. That fills the dynamic range of the streams of information as best as possible to discriminate between the candidate units. Once the norm of the final cost vector f is maximized, the minimum cost is chosen among the uniformly largest costs. For example, the stream of information that represents a pitch is maximized to a maximum value and becomes important. But if all candidate units have the substantially the same maximum value pitch, the pitch is not relevant for the purpose of discriminating between the candidate units. Therefore, the smallest final cost needs to be picked among uniformly large final costs, because the smallest final cost means the candidate unit that achieves the best fit.

First, the norm of f is maximized, for example:

∥f∥²=w^{T}Y^{T}Yw=w^{T}Qw,

where Q=Y^{T}Y, subject to the (linear combination) constraints that:

∥w∥²=w^{T}w=1, (3)

wⱼ>0, 1≦j≦K. (4)

The constraint (3) indicates that sum of all weights is equal one. Constraint (4) indicates that weights are positive, meaning that contribution from the stream of information should be positive.

Without the positivity constraint (4), this would be a standard quadratic optimization problem. The requirement that the weights all be positive (constraint (4)), however, may considerably complicate the mathematical outlook. To make the problem tractable, this requirement is first relaxed, and the resulting solution is modified to take it into account. As set forth below, this does not affect the suitability of the solution for the purpose intended.

When constraint (4) is relaxed, weights may be negative. A negative weight means that a particular direction in the eigenvalue space (stream of information) is important with a negative correlation. The amplitude represented, for example, by a square of a weight, an absolute value of a weight, provides an indication about a degree of importance of the stream of information.

Next, the component in the above maximal norm of vector f (2) which has minimal value, is selected. That is, the candidate unit is selected that is associated with the minimal costs.

Note that the (K×K) matrix Q is real, symmetric, and positive definite, which means there exist matrices P and Λ such that:

Q=PΛP^{T}, (5)

where P is the orthomormal matrix of eigenvectors Pⱼ(meaning that P^{T}P=PP^{T}=I_{K}, where I_{K} is the identity matrix of dimension K) and Λ is the diagonal matrix of eigenvalues λⱼ, 1≦j≦K.

Let us now (temporarily) ignore the wⱼ>0 constraint. From the Rayleigh-Ritz theorem, we know that the maximum of w^{T}Qw with w^{T}w=1 is given by the largest eigenvalue of Q, i.e., λₘₐₓ, and that this maximum is achieved when w is set equal to the associated eigenvector, pₘₐₓ. This solution for W may not be appropriate for a weight vector, because the elements of pₘₐₓ are not, in general non-negative. The elements of eigenvector pₘₐₓ may represent weights of the streams of information.

On the other hand, the coordinates of pₘₐₓ, by definition, reflect the relative contribution of each of the original axes (i.e., streams of information) to the direction that best explains the input data (i.e., the scores gathered for each stream). It is therefore reasonable to expect that a simple transformation of these coordinates, such as absolute value or squaring, would produce non-negative weights with much of the qualitative behavior sought. That is, the signs of pⱼ eigenvectors do not matter for weighting the stream of information. Therefore, the signs can be ignored, and the squares of pⱼ eigenvectors may be taken to get positive values.

Following this reasoning, we set the optimal weight vector w* to be:

w*=pₘₐₓ·pₘₐₓ, (6)

Where “·” denotes component-by-component multiplication. Clearly, this solution satisfies all the constraints (3)-(4). The associated final cost vector is then obtained as:

Yw*=f*, (7)

which finally leads to the index of the best candidate at the concatenation considered:

i*=arg min fᵢ* (8)

1≦i≦M

As shown in (8) the candidate which has the minimum final cost is selected.

Interestingly, a side benefit of this approach is that the resulting final cost vector f* is automatically normalized to the range [0,1], which makes the entire unit selection process more consistent across the various concatenations considered, for example, in the Viterbi search.

Referring back to FIG. 4, method continues with operation 404 that involves determining final costs for the candidate units of the pool using the set of weights. A candidate unit is selected from the pool of the candidate units based on the final costs at operation 405. In one embodiment, the candidate unit is selected that has a minimal final cost, as described above with respect to equation (8). Next, at operation 406 (optional) the selected candidate unit is concatenated with a previously selected candidate unit.

At operation 407 a determination is made whether a next candidate unit needs to be concatenated with a previous unit, such as the unit selected at operation 405. If there is a next unit to be concatenated with the previously selected candidate unit, method 400 returns to operation 401 to determine scores associated with streams of information for next candidate units associated with a next input unit. A next matrix of the scores for the next candidate units may be generated at operation 402. A next set of weights may be determined using the next matrix at operation 403. Next final costs for next candidate units may be determined using the next set of weights at operation 404. A next candidate unit from the next candidate units may be selected based on the next final costs at operation 405. The next selected candidate unit is then concatenated with the previously selected candidate unit at operation 406. If there is no next unit to be selected, method 400 ends at block 408.

An evaluation of methods, as described above, was conducted using a database, such as a voice table that is currently being developed on MacOS X®. The voice table was constructed from over 10,000 utterances carefully spoken by an adult male speaker. One of these utterances was the sentence “Bottom lines are much shorter”. Because of that, the focus of an initial experiment was the sentence “Bottom lines are much longer”, which only differs in the last word, and has otherwise similar pitch and duration patterns as the original utterance “Bottom lines are much shorter”. Because the two sentences are so close, it was expected that the (word-based) unit selection procedure would pull the first four words out of the original sentence “Bottom lines are much shorter”, and only take the last word from some other material (utterance).

However, this is not what was observed with the baseline standard system using a linear score combination with manually adjusted weights, as described above. Instead, only the first two words “Bottom lines” were picked from the original sentence. The words “are” and “much” were selected from other material. Such selection may be a result of a potentially deleterious effect of global weighting technique used in the standard system. That is, the standard system is not optimal to select the candidate units of at least a portion of the sentence.

Then, the candidate units were selected for sentence “Bottom lines are much longer” using context-aware optimal cost weighting approach for unit selection, as described above. For each unit in the sentence, all possible candidates were extracted from the voice table, such as M=16 (for “Bottom”), M=10 (for “lines”), M=796 (for “are”), M=92 (for “much”), and M=11 (for “longer”) words, respectively. Each time (for example, at each concatenation), K=4 streams of information were considered, namely: (i) the concatenation cost calculated between the candidate and the previous unit, (ii) the pitch cost calculated between the ideal pitch contour and that of the candidate, (iii) the duration cost calculated between the ideal duration and that of the candidate, and (iv) the position cost calculated between the ideal location within the utterance and that of the candidate. The (M×K) input matrix was formed in each case, and the optimal weights and final costs were computed, as detailed above.

This resulted in the same candidates being ultimately selected for the words “Bottom”, “lines”, and “longer”. This time, however, different candidates were picked for both “are” and “much”, namely the contiguous candidates that we had originally expected to be chosen, whereas the candidates selected by the baseline system were relegated to ranks 15 and 17, respectively.

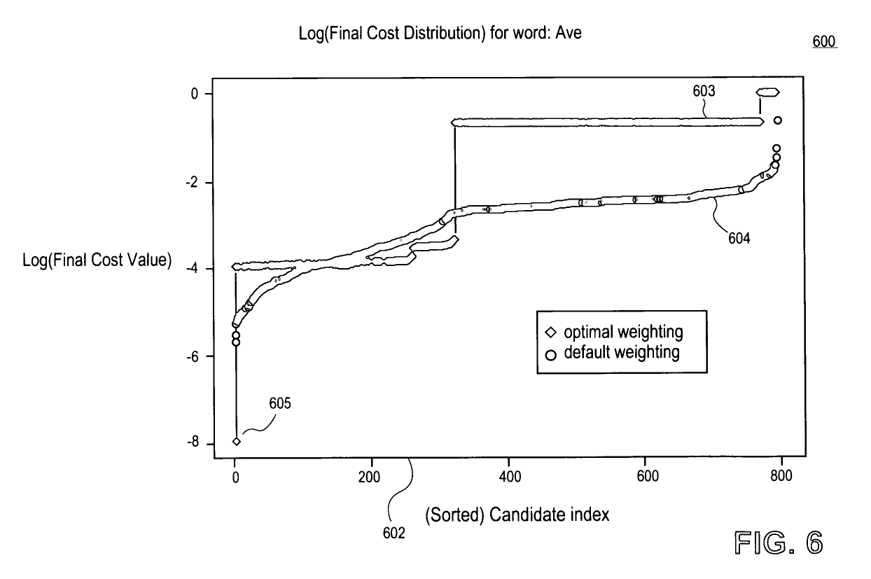

FIG. 6 illustrates the sorted final costs for word “are”, for both context-aware optimal cost weighting and standard (default) weighting. FIG. 6 illustrates a plot of final cost values 601 versus candidate index 602 for default weighting 604 and optimal weighting 603. As shown in FIG. 6, in the optimal weighting 603, the contiguous candidate has a much lower cost 605 than any non-contiguous candidates, reflecting a much greater emphasis on the concatenation score. That is, contiguous candidate “are” from the sentence “bottom lines are shorter” having the lowest final cost 605 was selected using the context-aware optimal cost weighting. The optimal weighting provides high level of discrimination between the selected candidate having lowest final cost 605 and any other candidate, as shown in FIG. 6.

In the default weighting 604 the weighting vector was [0.125 (concatenation cost), 0.5 (pitch cost), 0.25 (duration cost), 0.125 (position cost)], thereby mostly emphasizing pitch, whereas in the optimal case it changed to [0.98(concatenation cost), 0,0 (pitch cost), 02 (duration cost), 0 (position cost)], thereby heavily weighting contiguity. This seems intuitively reasonable, as for this function word co-articulation was always somewhat noticeable, while the pitch contours for all candidates were very close to each other anyway.

Even though for some of the words the same candidates were ultimately picked, the optimal weight vectors returned by the context-aware optimum cost weighting algorithm were markedly different as well.

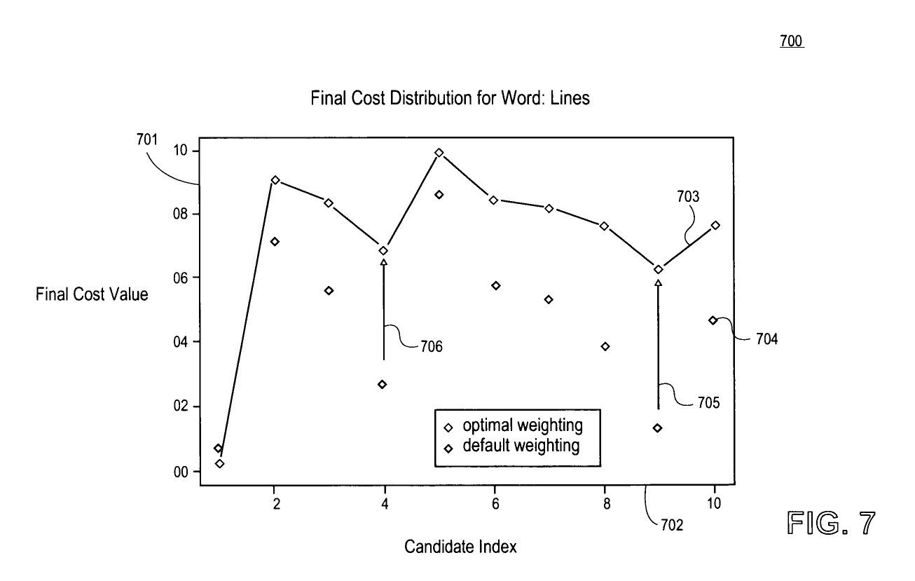

FIG. 7 illustrates the sorted final costs for word “lines”, for both context-aware optimal cost weighting and standard (default) weighting. A plot of final cost values 701 is shown in FIG. 7 versus candidate index 702 for default weighting 704 and optimal weighting 703. For example, for “lines”, the weight vector changed from [0.125(concatenation cost), 0.5(pitch cost), 0.25 (duration cost), 0.125(position cost)] to [0.61(concatenation cost), 0.21(pitch cost), 0.18 (duration cost), 0(position cost)]. That is, in the optimal weighting 703 the weights in a combination (set) of the streams of information are redistributed such that concatenation (e.g., stream of information that represents contiguity) becomes most important. FIG. 7, which compares the resulting (unsorted) final cost distributions 704 and 704, makes it quite clear that the new weights lead to a much better discrimination between, for example, Candidate 1 and Candidate 9. As shown in FIG. 7, the difference in score between Candidate 9 and Candidate 1 substantially increases 705 for optimal weighting 703 relative to default weighting 705. Finally, although in the previous two examples contiguity was clearly deemed the most dominant aspect of unit selection, this was not systematically the case.

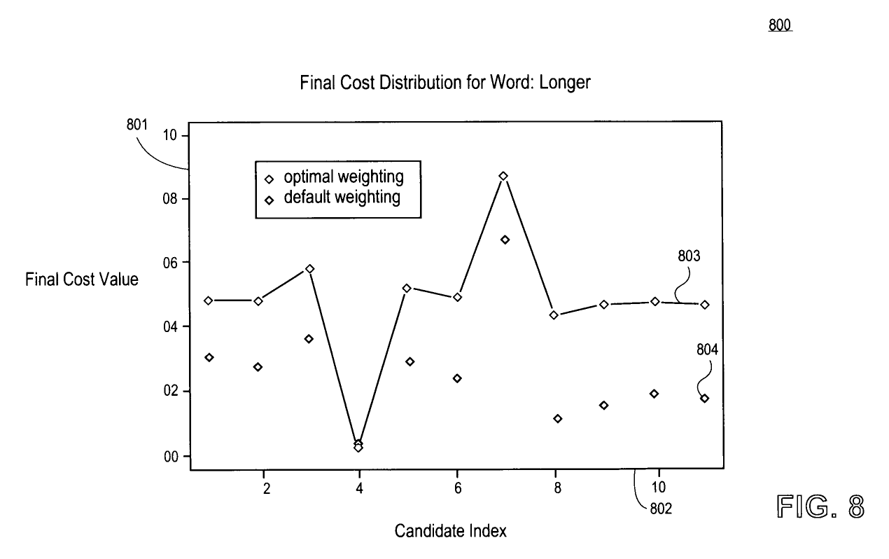

FIG. 8 illustrates the sorted final costs for word “longer”, for both context-aware optimal cost weighting and standard (default) weighting. A plot of final cost values 801 is shown in FIG. 8 versus candidate index 802 for default weighting 804 and optimal weighting 803. For “longer”, the weight vector changed from (0.125,0.5,0.25,0.125) to (0,0.15,0.15,0.7). In this case the most discriminative score was the position within the utterance (reflecting, here, the fact that the candidate was the last word in the sentence, which again makes a great deal of intuitive sense). That is, in the optimal weighting 803 the weights in a combination (set) of the streams of information are redistributed such that position (e.g., stream of information that represents position) becomes most important. FIG. 8, which compares the resulting (unsorted) final cost distributions, makes it quite clear that the new weights lead to a much better discrimination between, for example, Candidate 4 and Candidate 8.

Consistent results were obtained when performing the same kind of evaluation on other sentences from the same database. This bodes well for the viability of the proposed approach when it comes to determining context-aware optimal weights in concatenative text-to-speech synthesis.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing”, “computing”, “calculating”, “determining” and the like, refer to the action and processes of a data processing system, or similar electronic computing device, that manipulates and transforms data represented as physical (electronic) quantities within the data processing system's registers and memories into other data similarly represented as physical quantities within the data processing system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention. The specification and drawings are, accordingly, to be regarded in an illustrative sense rather than a restrictive sense.

What is claimed is:

1. A machine-implemented method, comprising:
analyzing streams of information in a context associated with first candidate units to determine a distribution of the streams of information over the first candidate units;
determining a first set of weights of streams of information according to the distribution; and
selecting a first candidate unit from the first candidate units based on the first set of weights of the streams of information.

2. The machine-implemented method as in claim 1, further comprising:
analyzing the streams of information in the context associated with second candidate units to determine a second set of weights of streams of information; and
selecting a second candidate unit from second candidate units to concatenate with the first candidate unit based on the second set of weights of streams of information.

3. The machine-implemented method of claim 1, wherein the analyzing includes:
weighting a first stream of information of the streams of information higher if the first stream of information provides a high discrimination between the first candidate units.

4. The machine-implemented method of claim 1, wherein the analyzing includes:
weighting a second stream of information of the streams of information lower if the second stream of information provides a low discrimination between the first candidate units.

5. The machine-implemented method of claim 1, wherein a stream of information of the streams of information is to represent a characteristic associated with an input unit.

6. A machine-implemented method, comprising:
determining first scores associated with streams of information for first candidate units associated with a first input unit;
generating a first matrix of the first scores for the first candidate units;
determining a first set of weights using the first matrix;
determining first final costs for the first candidate units using the first set of weights;
selecting a first candidate unit from the first candidate units based on the first final costs.

7. The machine-implemented method of claim 6, further comprising:
normalizing the scores across the candidate units.

8. The machine-implemented method of claim 6, wherein the determining the first set of weights includes maximizing the first final costs for the first candidate units.

9. The machine-implemented method of claim 6, wherein the first candidate unit has a minimal final cost.

10. The machine-implemented method of claim 6, wherein a stream of information of the streams of information includes a cost function.

11. The machine-implemented method of claim 6, further comprising:
determining second scores associated with streams of information for second candidate units associated with a second input unit;
generating a second matrix of the second scores for second candidate units;
determining a first set of weights using the second matrix;
determining second final costs for second candidate units using the second set of weights;
selecting a second candidate unit from the second candidate units based on the second final costs.

12. A machine-readable medium containing executable program instructions which cause a data processing system to perform operations comprising:
analyzing streams of information in a context associated with first candidate units to determine a distribution of the streams of information over the first candidate units;
determining a first set of weights of streams of information; and
selecting a first candidate unit from the first candidate units based on the first set of weights of the streams of information.

13. The machine-readable medium of claim 12, further including data that cause the data processing system to perform operations comprising:
analyzing the streams of information in the context associated with second candidate units to determine a second set of weights of the streams of information; and
selecting a second candidate unit from second candidate units to concatenate with the first candidate unit based on the second set of weights of the streams of information.

14. The machine-readable medium of claim 12, wherein the analyzing includes weighting a first stream of information of the streams of information higher if the first stream of information provides a high discrimination between the first candidate units.

15. The machine-readable medium of claim 12, wherein the analyzing includes weighting a second stream of information of the streams of information lower if the second stream of information provides a low discrimination between the first candidate units.

16. The machine-readable medium of claim 12, wherein a stream of information of the streams of information is to represent a characteristic associated with an input unit.

17. A machine-readable medium containing executable program instructions which cause a data processing system to perform operations comprising:
determining first scores associated with streams of information for first candidate units associated with a first input unit;
generating a first matrix of the first scores for the first candidate units;
determining a first set of weights using the first matrix;
determining first final costs for the first candidate units using the first set of weights;
selecting a first candidate unit from the first candidate units based on the first final costs.

18. The machine-readable medium of claim 17, further including data that cause the data processing system to perform operations comprising:
normalizing the scores across the candidate units.

19. The machine-readable medium of claim 17, wherein the determining the first set of weights includes maximizing the first final costs for the first candidate units.

20. The machine-readable medium of claim 17, wherein the first candidate unit has a minimal final cost.

21. The machine-readable medium of claim 17, wherein a stream of information of the streams of information includes a cost function.

22. The machine-readable medium of claim 17, further including data that cause the data processing system to perform operations comprising:
determining second scores associated with streams of information for second candidate units associated with a second input unit;
generating a second matrix of the second scores for second candidate units;
determining a first set of weights using the second matrix;
determining second final costs for second candidate units using the second set of weights;
selecting a second candidate unit from the second candidate units based on the second final costs.

23. A data processing system, comprising:
means for analyzing streams of information in a context associated with first candidate units to determine a distribution of the streams of information;
means for determining a first set of weights of the streams of information according to the distribution; and
means for selecting a first candidate unit from the first candidate units based on the first set of weights of the streams of information.

24. The data processing system as in claim 23, further comprising:
means for analyzing the streams of information in the context associated with second candidate units to determine a second set of weights of the streams of information; and
means for selecting a second candidate unit from second candidate units to concatenate with the first candidate unit based on the second set of weights of the streams of information.

25. The data processing system of claim 23 further comprising:
means for determining first scores associated with the streams of information for the first candidate units associated with a first input unit;
means for generating a first matrix of the first scores for the first candidate units;
means for determining a first set of weights using the first matrix;
means for determining first final costs for the first candidate units using the first set of weights; and
means for selecting the first candidate unit from the first candidate units based on the first final costs.
